(19) United States
(12) Patent Application Publication
(10) Pub. No.: US 2021/0299688 A1
(43) Pub. Date: Sep. 30, 2021

(54) RECYCLABLE VACUUM-DRIVEN DISPENSER

(71) Applicant: EASY SPRAY LLC, Lake St. Louis, MO (US)

(72) Inventors: Robert Craig ALLEN, Richmond Heights, OH (US); Shawn DELLINGER, Cleveland Heights, OH (US); Donald C. FUCHS, Mentor, OH (US); Robert SOREO, Cleveland Heights, OH (US)

(21) Appl. No.: 17/218,929

(22) Filed: Mar. 31, 2021

Related U.S. Application Data
(60) Provisional application No. 63/002,483, filed on Mar. 31, 2020.

(51) Int. Cl. B05B 11/00

(52) U.S. Cl. CPC B05B 11/3014; B05B 11/3067; B05B 11/3057; B05B 11/3047

(57) ABSTRACT

Aerosol-free spray devices are provided. According to some embodiments, an aerosol-free spray device includes a piston operable within a piston chamber and coupled to a vacuum plunger operable within a vacuum chamber. Each component, including valves, of the aerosol-free spray device is composed of recyclable material of the same resin identification number. With the entire device made of material of the same resin identification number, the spray device is entirely and easily recyclable.

### CROSS-REFERENCE TO RELATED APPLICATION

This application claims priority benefit of U.S. Provisional Patent Application Ser. No. 63/002,483 filed Mar. 31, 2020, entitled “RECYCLABLE VACUUM-DRIVEN DISPENSER,” the complete disclosure of which is herein incorporated by reference in its entirety.

### FIELD

The following description generally relates to vacuum-driven fluid delivery devices and more to vacuum-driven fluid delivery devices composed of recyclable material.

### BACKGROUND

Many known continuous-spray devices for spraying liquids use aerosol propellants. Such devices are considered by many to be harmful to the environment, and are targeted for regulation/elimination by federal and state agencies. On the other hand, many known finger-sprayers and trigger sprayers can be difficult or tedious to operate, as dispensing the product requires constant pumping and can only deliver an intermittent liquid spray upon a single actuation of the device. However, the form factor of these hand held finger sprayers is generally more ergonomic and easier to aim than top depressing aerosol cans. Furthermore, many current continuous-spray and trigger sprayer devices are made of materials and/or are assembled such that recycling the entire spray device is not possible or difficult and the empty device is discarded into a landfill.

A vacuum-driven fluid delivery device outputs fluid under a force generated by a vacuum in a vacuum chamber. An example of a vacuum-driven fluid delivery device is disclosed in U.S. Pat. No. 8,973,847 by Iammatteo and Bicej, issued on Mar. 10, 2015, the entire disclosure of which is incorporated herein by reference for all purposes. Improvements, to vacuum-driven fluid delivery devices include preventing undesirable loss in maximum vacuum volume of the vacuum chamber during storage of the device in a charged state as disclosed in U.S. Pat. No. 10,233,914 by Iammatteo and Bicej, issued on Mar. 19, 2019, the entire disclosure of which is incorporated herein by reference for all purposes.

Accordingly, it is desirable to provide a vacuum-driven fluid delivery device, that provides a sufficient spray function, is easily and entirely recyclable as well as embodied in a comfortable ergonomic form factor. The present disclosure provides certain improvements to vacuum-driven fluid delivery devices to address these and other needs.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Described herein are aerosol-free spray devices and methods of spraying a fluid without the use of an aerosol propellant. According to some embodiments, an aerosol-free spray device includes a piston operable within a piston chamber and coupled to a vacuum plunger operable within a vacuum chamber. Each component, including valves, of the aerosol-free spray device is composed of recyclable material of the same resin identification number. With the entire device made of material of the same resin identification number, the spray device is entirely and easily recyclable.

In accordance with one aspect of the present disclosure, an exemplary spray device is described. The spray device includes a body defining a reservoir for holding a fluid and a piston and plunger assembly including a piston and a vacuum plunger mechanically coupled for unitary reciprocating movement along a first axis. The spray device includes a first chamber configured to slidingly receive the piston therein and fill with fluid received from the reservoir when the first piston is displaced away from the first chamber. The device includes a second chamber configured to slidingly receive the vacuum plunger therein and generate a vacuum therein when the vacuum plunger is displaced in a direction away from the second chamber, the vacuum generating a force on the fluid in the first chamber via the position plunger assembly to cause the fluid in the first chamber to be output from the fluid delivery device through an outlet valve of the first chamber when the outlet valve is open. The body, piston and plunger assembly, first chamber and second chamber are each composed of recyclable polymers. In some embodiments, each of the recyclable polymers are of the same resin identification number. In a further embodiment, the polymer blend having the same resin identification number comprises polypropylene with resin number 5.

In another further embodiment, the first chamber is concentric within the second chamber. In another further embodiment, the vacuum plunger is composed of a first polymer blend and the second chamber is composed of a second polymer blend, wherein the a first hardness value of the first polymer blend is less than a second hardness value of the second polymer blend. In another further embodiment, the vacuum plunger comprises a plunger head on a distal end of the vacuum and configured to slidably reciprocate and create a seal within the vacuum chamber, the plunger head comprising a polymer blend identical to the vacuum plunger. In another further embodiment, the plunger head comprises a substantially u-shaped cross section with outwardly extending ramped seal walls configured to sealing abut interior walls of the second chamber. In another further embodiment, the recyclable spray device further includes a first valve configured to control a first flow of the fluid between the reservoir and the first chamber. The first valve includes a valve body having and a valve member configured for moment into and out of engagement with a complementary shaped valve seat of the valve body. The valve member and valve body are each composed of the polymer blend having the same resin identification number. In another further embodiment, the valve member is made of a valve member polymer blend and the valve body is made of a valve body polymer blend, wherein the valve member polymer blend is softer than the valve body polymer blend. In another further embodiment, the recyclable spray device further includes a leak channel defining a gap between the valve seat and seated valve member, the leak channel allowing pressurized fluid to flow from the first chamber back into the reservoir. In another further embodiment, the first valve is formed at the bottom of a base of the piston and plunger assembly and is in fluid communication between the reservoir and first chamber.

In another further embodiment, the spray device further includes a spray assembly configured to selectively discharge pressurized fluid from the fluidly connected first chamber. The spray assembly includes a lever pivotally connected to the interior of a spray head and mechanically coupled a spray valve, the lever, and valve are each composed of the polymer blend having the same resin identification number. In another further embodiment, the spray valve comprises a spray valve seat and spray valve member, the spray valve member configured to engage a complementary recess in the spray valve seat. In another further embodiment, the spray valve member includes a valve stem configured for axial movement within a bore of the valve seat along a valve stem axis. The valve stem includes a sealing portion of increased diameter configured to provide a fluid tight seal between the sealing portion and bore of the valve seat when the sealing portion is urged into contact with the valve seat. In another further embodiment, the lever includes a pair of biasing wings positioned on and extending generally perpendicular to a valve stem axis. Each basing wing is configured to couple to a biasing wall of the spray assembly and urge the lever and mechanically coupled spray valve to a sealed position. Upon application of a force to the lever, the valve seat is pushed along the valve seat axis and the biasing wings deform such that when the force to the lever is removed, the deformation of the biasing wings restore the lever and valve seat to the sealed position. In another further embodiment, the spray valve is composed of a spray valve polymer blend and the spray valve member is composed of a spray valve member polymer blend, wherein the spray valve member polymer blend is softer than the spray valve polymer blend.

In accordance with another aspect of the present disclosure, an exemplary fluid delivery device is described. The exemplary device includes a reservoir configured to contain a fluid and a chamber in fluid communication with the reservoir and configured hold an amount of pressurized fluid therein. The device also includes a spray assembly configured to selectively output a portion of the pressurized fluid from the chamber. The spray assembly includes, a spray valve seat and spray valve member, the spray valve member configured to engage a complementary recess in the spray valve seat and selectively seal the flow of pressurized fluid from the chamber and a lever pivotally connected to the interior of a spray head and mechanically coupled to the spray valve seat to affect disengagement of the valve member from the valve seat. The reservoir, chamber, and spray assembly are each composed of recyclable polymers. In a further embodiment, the fluid delivery device according further includes a first plunger configured to generate a vacuum in a second chamber responsive to movement of the first plunger in a first direction and a piston configured to move in the first direction in response to movement of the first plunger in the first direction to cause a portion of the fluid to flow from the fluid reservoir through a flow valve and into the chamber, and configured to apply a force generated by the vacuum to the portion of the fluid in the chamber. The first and second plunger are each composed of the polymer blend having the same resin identification number. In another further embodiment, the fluid delivery device further includes a flow valve configured to control a flow of the fluid between the fluid reservoir and the chamber. The flow valve includes a valve body having and a valve member configured for moment into and out of engagement with a complementary shaped valve seat of the valve body, wherein the valve member and valve body are each composed of the polymer blend having the same resin identification number. In another further embodiment, the flow valve further includes a leak channel defining a gap between the valve seat and valve member, the leak channel allowing pressurized fluid to flow from the first chamber back into the reservoir. In another further embodiment, the polymer blend having the same resin identification number is of one of a first polymer blend having a first hardness and a second polymer blend having a second hardness, wherein the first hardness is greater than the second hardness.

In accordance with another aspect of the present disclosure, another exemplary embodiment of a fluid delivery device is disclosed. The fluid delivery device includes a reservoir configured to contain a fluid and a chamber in fluid communication with the reservoir and configured hold an amount of pressurized fluid therein. A first valve is configured to control a first flow of the fluid between the reservoir and the first chamber, the first valve comprising a valve body and a valve member configured for moment into and out of engagement with a complementary shaped valve seat of the valve body. The valve includes a leak channel defining a gap between the valve seat and seated valve member, the leak channel allowing pressurized fluid to flow from the first chamber back into the reservoir. Each component is composed of a recyclable polymer. In some embodiments, each of the recyclable polymers are of the same resin identification number. In a further embodiment, the polymer blend having the same resin identification number comprises polypropylene with resin number 5.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1A is a cross-sectional view of a fluid spray device according to an embodiment of the invention, wherein the spray device is in an initial, uncharged, configuration.

FIG. 1B is an exploded view of the fluid spray device of FIG. 1A.

FIG. 2A is a side perspective view of a piston and plunger base of the fluid spray device of FIG. 1A.

FIG. 2B is a bottom perspective view of a piston and plunger base of the fluid spray device of FIG. 1A.

FIG. 3 is a magnified cross-sectional view a piston and plunger of the fluid spray device of FIG. 1A.

FIG. 4A is a magnified cross-sectional view of a flow valve of the spray device of FIG. 1A, wherein the flow valve is in an unsealed configuration.

FIG. 4B is a magnified cross-sectional view of a flow valve of the spray device of FIG. 1A, wherein the flow valve is in a sealed configuration.

FIG. 5A is a magnified cross-sectional view of a spray assembly.

FIG. 5B is a magnified cross-sectional view of an exploded spray valve of the spray assembly of FIG. 5A.

FIG. 6 is an alternative embodiment of a spray valve of a spray assembly.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are therefore not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

Numerical values in the specification and claims of this application should be understood to include numerical values which are the same when reduced to the same number of significant figures and numerical values which differ from the stated value by less than the experimental error of conventional measurement technique of the type described in the present application to determine the value.

The terms “about” and “approximately” can be used to include any numerical value that can vary without changing the basic function of that value. When used with a range, “about” and “approximately” also disclose the range defined by the absolute values of the two endpoints, e.g. “about 2 to about 4” also discloses the range “from 2 to 4.” Generally, the terms “about” and “approximately” may refer to plus or minus 10% of the indicated number.

As used herein, the terms “generally” and “substantially” are intended to encompass structural or numerical modifications which do not significantly affect the purpose of the element or number modified by such term.

The spray device and components thereof are composed of recyclable materials such that when the device has reached the end of its service life, the entire spray device may be placed in the recycling bin. That is, an end consumer done with the product is able to recycle the entire spray device with minimal to no disassembly and separation of components required. Each component may be made of a recyclable polymer material for example and without limitation, polypropylene, having the resin identification code “5” for recycling. Currently, there are six (6), resin identification closes that represent the material of a plastic item. The number 1 is for polyethylene terephthalate (PET or PETE), 2 is for high-density polyethylene (HDPE), 3 is for polyvinyl chloride (PVC), 4 is for low-density polyethylene (LDPE), 5 is for polypropylene (PP), and 6 is for polystyrene (PS). Ideally, each component of a single-spray device is made of material of the same resin identification number.

Polypropylene is a thermoplastic polymer belonging to the group of polyolefins and is partiallycrystalline and non-polar. Its properties are similar to polyethylene, but is generally slightly harder and more heat resistant. It is generally a white, mechanically rugged material and has a high chemical resistance. The properties of polypropylene depend on the molecular weight and molecular weight distribution, crystallinity, type and proportion of comonomer (if used) and the isotacticity. In isotactic polypropylene, for example, the methyl groups are oriented on one side of the carbon backbone. This arrangement creates a greater degree of crystallinity and results in a stiffer material that is more resistant to creep (cold flow) than both atactic polypropylene and polyethylene. Polypropylene at room temperature is resistant to fats and almost all organic solvents, apart from strong oxidants.

A common shaping technique for polypropylene is injection molding, which is used for parts such as cups, cutlery, vials, caps, containers, housewares, and automotive parts such as batteries. The large number of end-use applications for polypropylene are often possible because of the ability to tailor grades with specific molecular properties and additives during its manufacture. For example, additives can be added to help polypropylene surfaces resist dust and dirt. As polypropylene is generally resistant to fatigue, most plastic living hinges, such as those on flip-top bottles, are made from this material.

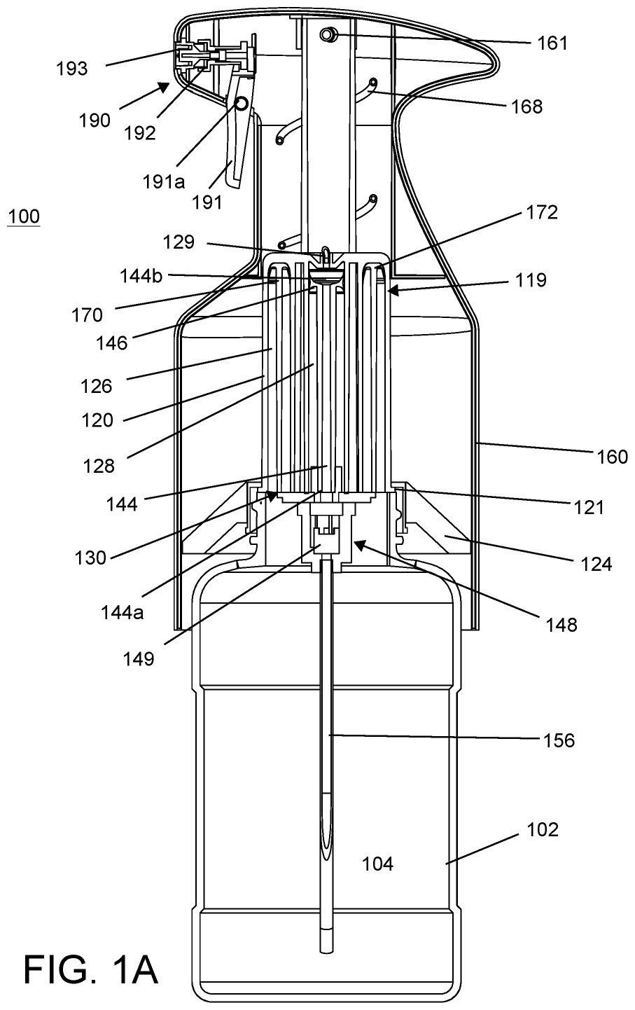

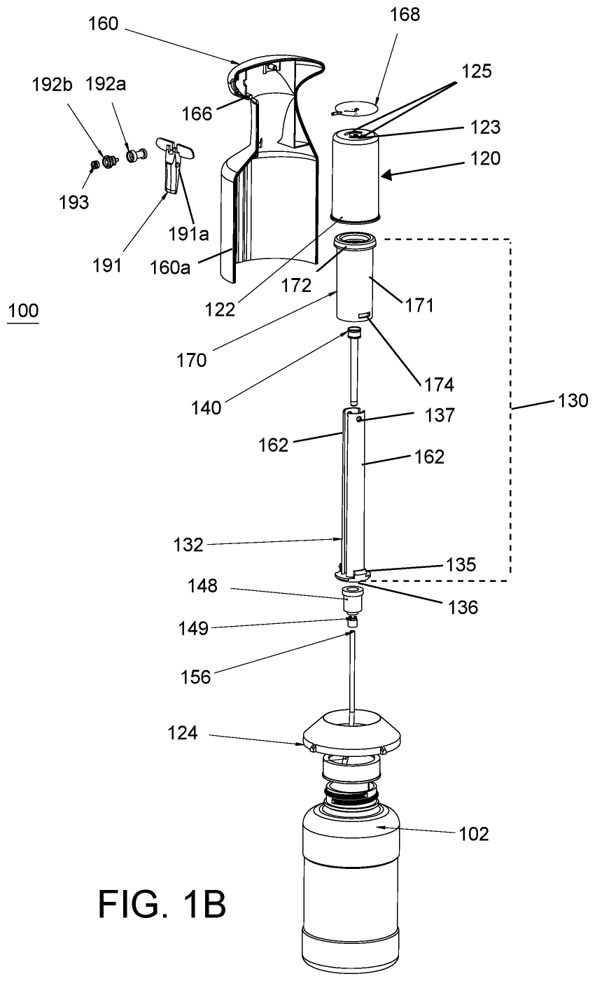

FIGS. 1A and 1B, illustrate cross-sectional and exploded views, respectively of an exemplary spray device 100 in accordance with the present disclosure. The device 100 includes a bottle body 102 defining an interior liquid reservoir 104 containing a liquid to be sprayed from the device 100, for example from a spray head/spray assembly described in greater detail below. The device 100 further includes a charger 160 that is operable to place the device 100 in a charged configuration in which the device 100 is ready to spray liquid, and a spray actuator 119 that is operable to release liquid spray from the spray device 100. Each of the components of the device 100 (described below) are generally constructed of recyclable material, for example and without limitation, polypropylene.

The charger 160 is a substantially hollow cylinder and can be fitted over a twin cylinder 120 and operatively coupled to a piston and plunger assembly 130, each described in greater detail below. The charger 160 is configured such that its side walls 160a slide over the top portion of the bottle body 102 when the charger 160 is reciprocated along the Y-axis of the device 100.

The spray device 100 includes a twin cylinder 120 fitted on upper portion of the bottle body 102. As shown in FIGS. 1A and 1B, the twin cylinder 120 includes a substantially hollow, cylindrical cylinder body 122. The twin cylinder 120 can be secured in a generally fixed position with respect to the bottle body 102 by an interference/press fit or threaded engagement between a bottom peripheral flange 121 of the cylinder body 122 and an outer surface of the bottle body 102, or retaining member 124 configured to the engage the peripheral flange 121.

The twin cylinder 120 is divided into a vacuum chamber 126 and a piston chamber 128. The piston chamber 128 extends vertically through the center of the cylinder body 122, and a vacuum chamber 126, having an annular cross-section, concentrically surrounds the piston chamber 128. Preferably, the volume of the vacuum chamber 126 is larger than the volume of the piston chamber 128. The piston chamber 128 includes an exit port 129 for moving fluid out of the piston chamber 128. Charger guide slots 125 are provided in the top face 123 of the cylinder 120 and extend vertically through the entire cylinder body 122 between the vacuum chamber 126 and piston chamber 128. Charger guide slots 125 provide for guiding reciprocating movement of a piston and plunger assembly 130, as will be described later in more detail. While the vacuum chamber 128 and piston chamber 128 are described and illustrated as being concentric, the relative positioning of each chamber is not limiting, and that these chambers may be placed anywhere within the spray actuator 119.

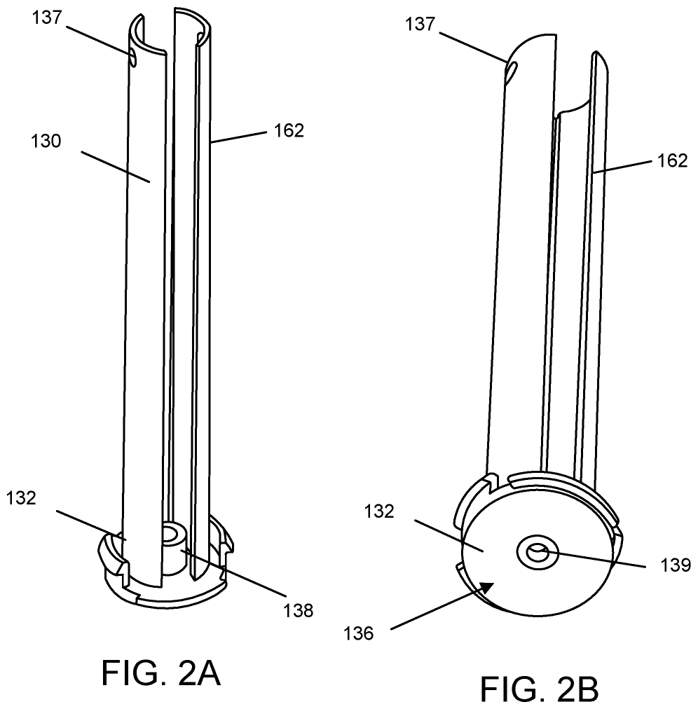

With reference to FIGS. 1A-2B, a piston and plunger assembly 130 is coupled to the spray device 100 and slidably interfaces with the twin cylinder 120. The piston and plunger assembly 130 includes a piston and plunger base 132 having at least one interior guide leg 162 (two are illustrated) that are received in the charger guide slots 125 of the twin cylinder 120 and may slide with respect thereto. The piston and plunger assembly 130 also includes a piston 140 that is positioned to slidably reciprocate along the Y-axis of the spray device 100 within the piston chamber 128 of the twin cylinder 120 in order to draw fluid into the piston chamber 128 and generate liquid spray. Similarly, the piston and plunger assembly 130 includes a vacuum plunger 170 having a plunger head 172 and sidewall 171 positioned to slidably reciprocate along the Y-axis of the spray device 100 within the vacuum chamber 126 of the twin cylinder 120 in order to create a vacuum in the vacuum chamber 126.

The bottom end 136 of the piston and plunger base 132 includes a piston seat 138 with a port 139, wherein the bottom end of the piston 140 is secured in the piston seat 138 such vertical translation of the piston and plunger base 132 provides for vertical translation of the secured piston 140. The piston 140 further includes an interior fluid passage 144 beginning at an inlet opening 144 a at the bottom end of the piston 140 and terminating at an exit opening 144 b at a piston head 146 at a top end of the piston 140. The inlet opening 144 a is aligned with the port 139 of the piston base 132.

The piston and plunger base 132 is secured internally to the plunger 170 via complementary snap fit tabs 135 located on the bottom end 136 of the piston and plunger base 132 and receiving slots 174 in the vacuum plunger sidewall 171. The piston and plunger base 132 is also secured to the interior of the charger 160, via at least one aperture 137 located on the top portion of the piston and plunger base 132, configured to engage a complementary shaped post 161 of the charger 160. The configuration of the charger 160, and the piston and plunger base 132 allows the piston and charger assembly 130, including the piston 140 and vacuum plunger 170 to move along the Y-axis in concert with respect to the twin cylinder 120. That is, the piston and plunger base 132 connect the piston 140 and plunger 170 such that they are enabled to exert forces upon each other to reciprocate the piston and plunger base 132, piston 140 and charger 160 along the Y-axis. While the piston 140 and plunger 170 are described and illustrated as being concentric, the relative positioning of each is not limiting, and these components may be placed such that they are received by corresponding piston and vacuum chambers.

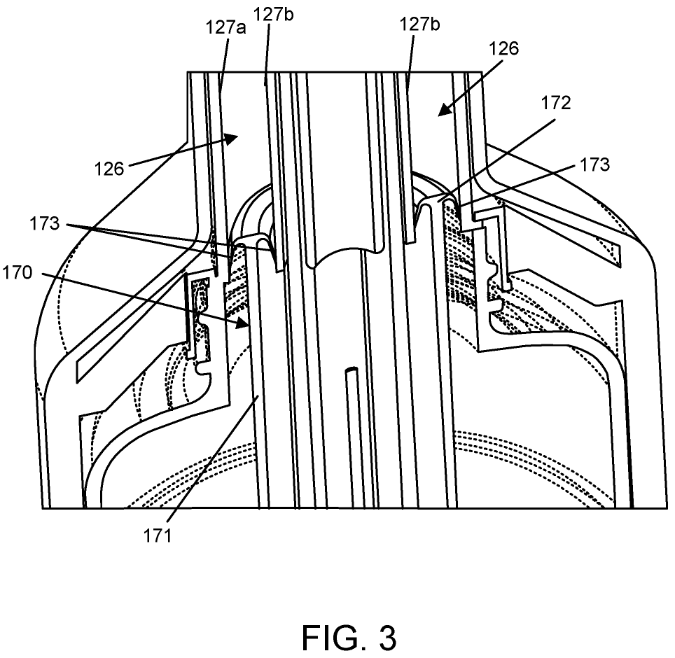

With reference to FIGS. 1A, 1B, and 3, the vacuum plunger 170 is illustrated as a hollow, cylindrical member having the plunger sidewall 171 and annular plunger head 172 at its top end. In conventional spray devices, a separate sealing member of an elastomeric material e.g., silicon, is attached to a plunger head to provide a tight fit with the interior walls of the vacuum chamber 126. However, the additional elastomeric material adversely affects the recyclability of the spray device 100, as either the conventional sealing member material cannot be recycled or significant disassembly is required by the end consumer or recycler to remove and separate the sealing member material.

In order to maximize the recyclability of the spray device 100 the vacuum plunger 170 including an shaped annular head 172 is composed of a material that shares the same resin identification number, e.g., resin identification number 5 (polypropylene) as the twin cylinder 120 (i.e., vacuum chamber walls 127a,b), and preferably the entire spray device 100. As illustrated in FIG. 3, the annular shaped head 172 has a substantially U-shaped cross-section with outwardly extending ramped seal walls 173 configured to sealingly abut the interior walls 127a, 127b of the vacuum chamber 126. That is, interior walls 127a, 127b are configured such that insertion of the vacuum plunger 170 compresses the seal walls 173 wherein the resiliency of the seal walls 173 applies a sealing/restoring force to the vacuum chamber 126 interior walls 127a, 127b.

In order to avoiding galling and/or scratching of the seal walls 173 and interior walls 127a,b, the vacuum plunger 170 and twin cylinder 120 may be configured to each have a different hardness value. This is generally accomplished with each part composing a separate material. However, in order enhance the ability of the entire device to be recycled, the material of each component (vacuum plunger 170 and twin cylinder 120) must be of the same resin identification number. Here, each of the vacuum plunger 170 and twin cylinder 120 are made of different polymer blends of the same polymer material. That is, each component (vacuum plunger 170 and twin cylinder 120) is characterized by incorporating either differing ratios of composition material or including different additives to the material composition. In this way, the vacuum plunger 170 and twin cylinder 120 are each composed of material of the same resin identification number, but each have a differing hardness valve that avoids galling and interior scratching that could cause the device 100 to leak vacuum during operation. In order words, the vacuum plunger 170 may be made of a first polymer blend while the twin cylinder is made of a second polymer blend, wherein the first polymer blend and second polymer blend share the same resin identification number. In some further embodiments, the vacuum plunger 170, including the annular shaped head 172 with outwardly extending ramped seal walls 173 is configured to be softer than the harder twin cylinder 120 i.e., having a hardness valve that is less than the hardness value of the twin cylinder. That is, the first polymer blend of the vacuum plunger 170 is softer than the second polymer blend of the twin cylinder.

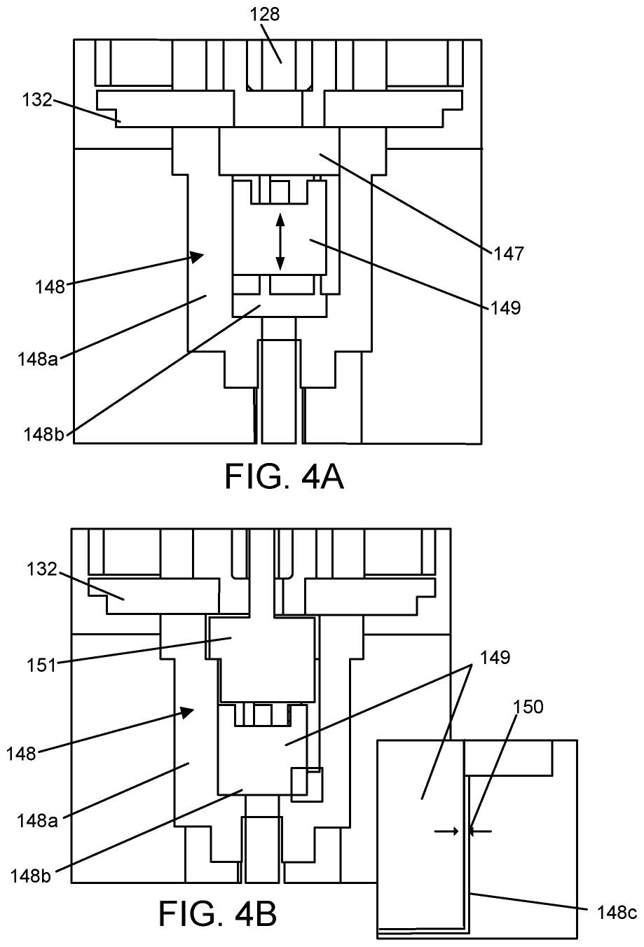

With reference to FIGS. 1A-B and 4A-B, a flow valve 148 is formed at the bottom end of the piston and plunger base 132 and includes a valve body 148a and a valve member 149. The flow valve 148 is situated between the piston and plunger assembly 130 and a lower flow tube 156, the lower flow tube 156 in fluid communication with fluid in the liquid reservoir 104, for controlling the flow of fluid there between. That is, the valve member 149 is configured for movement into and out of engagement with a complementary shaped valve seat 148b in the valve body 148a for controlling the flow of fluid between the liquid reservoir 104 and the fluid passage 144/piston chamber 128. As illustrated in FIG. 4B, the flow valve 148 is illustrated in a closed position in which the valve member 149 is seated within the valve seat 148b.

Similar to the vacuum plunger 170 and twin cylinder 120 discussed above, the valve body 148a and valve member 149 are each composed of a material of the same resin identification number. In some embodiments, the material of the valve member 149 and valve body 148a are identical. In other embodiments, the valve member 149 and valve body 148a are made of different polymer blends of the same polymer material. That is, each part (the valve body 148a and valve member 149) is characterized by incorporating differing ratios of composition material or including different additives to the material composition. In this way, the valve member 149 composed of a first valve polymer blend and valve body 148a composed of a second valve polymer blend may be configured to have a differing hardness valve that avoids galling and interior scratching that could cause the valve 148 to undesirably leak during operation. In some further embodiments, the first valve polymer blend of the valve member 149 is configured to be softer than the harder second valve polymer blend of the valve body 148a.

During charging of the spray device 100, the piston 140 and vacuum plunger 170, connected by the piston and plunger base 132, are displaced, generating a negative pressure within the piston chamber 128 and vacuum chamber 126, respectively. This negative pressure generates low pressure in the zone 147 above the valve member 149 displacing the valve member 149 from the valve seat 148b and drawing fluid up from the bottle 102. That is, the low pressure from the charging causes fluid to flow from the bottle 102, through the valve seat 148b and around the displaced valve member 149, and into to the fluid passage 144 of the piston 140 through the upper zone 147.

When the device 100 is in a charged state and the user stops moving the vacuum plunger 170 and the piston 140, the valve member 149 of the flow valve 148 returns to the sealing position under its bias force, thereby restricting flow of the fluid 151 from the piston chamber 128 to the fluid reservoir 100. The vacuum in the vacuum chamber 126 applies a force Fᵥ to the vacuum plunger 170 in a first direction. Due to its connection with the piston 140, the vacuum plunger 170 transmits the force Fᵥ to the piston 140. As a result, the piston 140 applies a force Fₒ, in the first direction, to the fluid in the piston chamber 128, thereby “charging” or pressurizing the fluid 151 such that the fluid can be selectively output from the piston chamber 128 through a spray assembly 190 to an outside of the device 100 under the force Fₒ, described in greater detail below.

When conventional vacuum-driven fluid delivery devices are stored (i.e., not operated) in a charged state, problems can occur. One such problem is that external gases from the surrounding environment can permeate into the vacuum chamber over time and occupy some or all of the volume initially containing the vacuum. Thus, the maximum volume of the vacuum in the vacuum chamber can decrease over time. Since the maximum duration of fluid output (e.g., spray) from the fluid outlet is determined by the volume of the vacuum in the vacuum chamber, a decrease in the maximum volume of the vacuum adversely affects performance of the device. Additionally, when conventional vacuum-driven fluid delivery devices are stored in a charged state, the forces (Fᵥ, Fₒ) generated by the vacuum in the vacuum chamber can place excessive stresses on the components of the device, causing the components to become damaged, deform or break when subjected to the vacuum over an extended period of time. Furthermore, according to examples, some or all of the components of vacuum-driven fluid delivery devices are constructed of thermoplastic materials, which suffer from creep when subjected to loading/stress over a sufficient period of time.

In order to avoid the above-described problems, the flow valve 148 is configured to allow the vacuum in the vacuum chamber 126 to slowly decrease when the device 100 is stored in a charged state by allowing a slow, controlled flow of the fluid 151 from the piston chamber 128 back into the fluid reservoir 104. That is, once the spray device 100 is charged, pressurized fluid 151 trapped in the piston chamber 128 pushes the valve member 149 into the valve seat 148b, hindering the flow of pressurized fluid 151 back into the bottle 102. As illustrated in the enlargement of FIG. 4B, the valve seat 148b includes a leak channel 148c that provides a gap 150 between the seated valve member 149 and valve seat 148a, that allows fluid to flow from the piston chamber 128 back into the bottle 102. In other words, the valve member 149 highly restricts/partially blocks flow of the fluid 151 from the piston chamber 128 to the fluid reservoir 104 in the seated position, but does not provide a completely fluid-tight seal. The dimensions of the gap 150 control leak rate of the fluid back to the bottle 102. s illustrated in the exemplary embodiment of FIG. 4B, the channel 148c may extend along both a vertical portion of the valve seat as well as a horizontal portion of the valve seat and in fluid communication with the liquid reservoir 104.

As briefly mentioned above and with reference to FIGS. 1A-B and 5A-B, the spray device 100 includes a spray assembly 190 configured to discharge pressurized fluid from the piston chamber 128. The spray assembly 190 is fluidly connected to the exit port 129 of the piston chamber 128 via an upper spiral tube 168. Accordingly, selective fluid communication is provided between the liquid reservoir 104, the lower tube 156, the liquid passage 144, the piston chamber 128 and the upper spiral tube 168.

The spray assembly 190 includes a lever 191, spray valve 192, and outlet 193. The lever 191 is pivotally coupled to the charger 160 via an aperture 191a configured to pivotally engage mounting post 166 of the charger 160. The lever 191 is also mechanically engaged with the spray valve 192 for actuating the valve 192 and dispensing pressurized fluid.

The spray valve 192 is generally composed of a spray valve seat 192a and a spray valve member 192b. The spray valve member 192b is generally cylindrical in shape and is configured to engage a complementary shaped recess 194 in the valve seat 192a. The spray valve member 192b also includes a valve stem 196 configured for axial movement within a bore 197 of the valve seat 192a along axis AA. The valve stem 196 includes a sealing member 196a of increased diameter such that a fluid tight seal is provided between the sealing member 196a and the bore 197 of the valve seat 192a.

The spray valve member 192b is generally in a secured position in relation to the charger body 160. For example, the spray valve member 192b may include a flange 192c configured to abut or couple to a corresponding interior wall 165 of the charger 160. The valve seat 192a, on the other hand, is mechanically coupled to the pivoting lever 191 and is configured to slide axially in relation to the valve member 192b with corresponding rotation of the lever 191. For example, the lever 191 includes a pocket 191a configured to receive and support the base 199 of the valve seat 192a.

The lever 191 includes a pair of biasing wings 191w positioned on and extending generally perpendicular to the axis AA of the valve stem 196 and bore 197. The biasing wings 191w are configured to couple to a biasing wall 167 of the charger 160 such that the tips of the wings are substantially fixed to the charger 160. In an undeformed state, the wings 191w bias the coupled valve seat 192b to sealingly engage the sealing member 196a of the valve stem 196. When a user actuates the lever 191, e.g., compressing the lever 191 toward the charger body 161, the lever rotates about the mounting post 166 and advances the coupled valve seat 192a axially. During actuation of the lever, the wings 191w, secured at its tips to the charger 160 twist/deform to accommodate advancement of the coupled valve seat 192a. In a completely pressed state of the lever (i.e., toward to charger body 161), the valve seat 192a travels along the valve stem 196 wherein the recess 194 of the valve seat 192b is urged into contact with the bottom edge of the valve member 192b. Axial advancement along the valve stem 196 (axis AA) causes the valve seat bore 197 to disengage the sealing member 196a, allowing fluid to flow through the valve 192 and out the outlet 193. The material of the wings 191w is selected that a restoring force biases the lever 191 from the deformed state to the undeformed state in the absence of lever actuation.

The outlet 193 is fitted to the valve 192 to provide a desired fluid spray pattern/characteristic based on a shape and size of one or more openings in the outlet 193 and the spacing/fitment of the outlet 193 within the fluid pathway of the spray assembly 190. The valve seat 192a, valve member 192b, and 193 define a fluid passage 198 through which pressured fluid may flow.

FIG. 6 illustrates another embodiment of a spray valve in accordance with the present disclosure. The spray valve 292 is composed of a spray valve seat 292a and a spray valve member 292b. The spray valve member 292b is generally cylindrical in shape and is configured to engage a complementary shaped recess 294 in the valve seat 292a. The spray valve member 292b also includes a valve stem 296 configured for axial movement within a bore 297 of the valve seat 292a. The valve stem 296 includes a sealing member 296a of increasing diameter such that a fluid tight seal is provided between the sealing member 296a and a complementary shaped bore 297. For example the sealing member 296a is a flared end of the valve stem 296 substantially conical in shape. The bore 297 is a cone shaped recess configured to receive the sealing member 296a of the valve stem for sealing engagement.

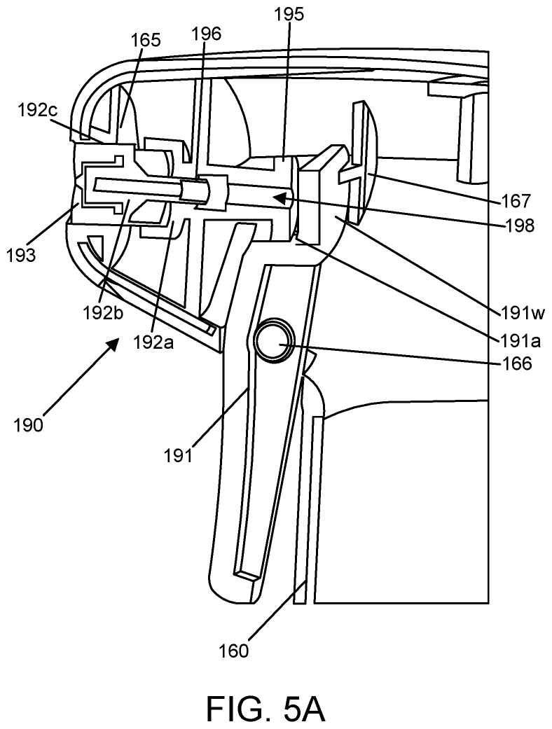

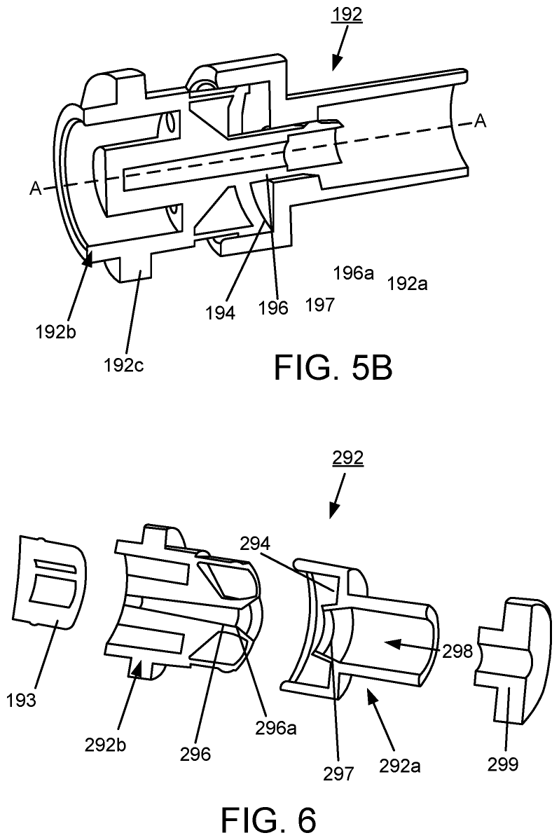

In some embodiments and as illustrated in FIG. 6, a spray valve includes a valve reducer 299. The valve reducer 299 is configured to fit within fluid passage 298 of the valve seat 292a. The valve reducer 299 provides a suitably sized hole to receive the tubing 168 coming from the product chamber. A valve reducer is also illustrated in the exemplary embodiment of FIG. 5A as element 195.

The operation of the device 100 will now be described with reference to FIG. 1A. In FIG. 1A the spray device 100 is in an initial, “uncharged” configuration in which it is not prepared to spray liquid from the liquid reservoir 104. In this position, the piston 140 and the plunger 170 are at the uppermost positions of their strokes. In order to “charge” the device 100 (i.e., place the device 100 in a position in which it is prepared to spray liquid), the charger 160 is pressed downwardly with respect to the bottle body 102. As the charger 160 is pressed downwardly, the charger 160 urges the piston and plunger base 132 downwardly, thereby simultaneously moving the piston 140 and the vacuum plunger 170 downwardly within the piston chamber 128 and the vacuum chamber 126, respectively. As the piston 140 moves downwardly, it generates a vacuum force in the interior passage 144 and the piston chamber 128, thereby causing the valve member 149 to be lifted from the valve seat 148 b and enabling fluid to enter the interior passage 144 and the piston chamber 128 from the reservoir 104 to fill the void created by the vacuum in the interior passage 144 and the piston chamber 128.

As the vacuum plunger 170 moves downwardly, a vacuum is created in the vacuum chamber 126, resulting in an upward force acting on the plunger 170 and the piston 140. Thus, downward motion charges the device 100 by loading the passage 144 and piston chamber 128 with fluid and generating a vacuum force in the vacuum chamber 126 that causes the piston 140 to pressurize the fluid in the passage 144 and piston chamber 128. The charger 160 can be depressed until the device 100 is placed in its fully charged configuration. When the spray device 100 is in the fully charged configuration, the charger 160 is in its lowermost position and the piston 140 and plunger 140 are locked in their fully charged positions such that the piston head and plunger head 172 are at the lowermost positions of their strokes.

Once the device 100 is placed in the fully charged configuration and a user releases or stops depressing the charger 160, there is no longer a vacuum force in the piston chamber 128 and the interior passage 144 of the piston. The vacuum force pressurizing the quantity of fluid in the piston chamber 128 causes the valve member 149 to engage the valve seat 148b, thereby placing the valve 148 back in the closed position and preventing any additional fluid from flowing into the interior passage 144 and the piston chamber 128. Because the piston valve 148 is closed, fluid pressure in the piston chamber 128, interior passage 144 and upper spiral tube 168 counteracts the upward force generated by the vacuum in the vacuum chamber 126, thereby locking the device 100 in the fully charged configuration.

Once the device 100 is in the fully charged configuration, the user can depress the lever 191 of the spray assembly 190 advance the valve seat 192b to disengage the sealing member 196a of the valve stem 196 against the restoring force of the deformed lever wings 191w. As a result, pressure in the piston chamber 128, the passage 144 and the upper spiral tube 168 is released, and the vacuum force in the vacuum chamber 126 forces plunger 170, and thus the piston 140 and plunger base 132 and the charger 160 upward with respect to the bottle body 102 and the twin cylinder 120. The upward movement of the piston 140 forces liquid to flow out of the piston chamber 128 and the interior passage 144, and then through the spray assembly 190 including insert 193 as a fluid spray. The fluid spray produced by the device 100 remains continuous until the user stops depressing the lever 191 or a maximum possible amount of the fluid in the piston chamber 128, the passage 144 and the upper spiral tube 168 has been sprayed out. Once the user stops depressing the spray actuator 190, valve seat 192b reengages the sealing member 196a of the valve stem 196 via the deformation restoring force of the wings 191w, thereby preventing further fluid spray from the device 100.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1. A spray device comprising:
a body defining a reservoir for holding a fluid;
a piston and plunger assembly including a piston and a vacuum plunger mechanically coupled for unitary reciprocating movement along a first axis;
a first chamber configured to slidingly receive the piston therein and fill with fluid received from the reservoir when the first piston is displaced away from the first chamber,
a second chamber configured to slidingly receive the vacuum plunger therein and generate a vacuum therein when the vacuum plunger is displaced in a direction away from the second chamber, the vacuum generating a force on the fluid in the first chamber via the position plunger assembly to cause the fluid in the first chamber to be output from the fluid delivery device through an outlet valve of the first chamber when the outlet valve is open,
wherein all components are composed of recyclable polymers.

2. The spray device according to claim 1, wherein the recyclable polymers are polymer blends having the same resin identification number.

3. The spray device according to claim 1, wherein the first chamber is concentric within the second chamber.

4. The spray device according to claim 1, wherein the vacuum plunger is composed of a first polymer blend and the second chamber is composed of a second polymer blend, wherein the a first hardness value of the first polymer blend is less than a second hardness value of the second polymer blend.

5. The spray device according to claim 1, wherein the vacuum plunger comprises a plunger head on a distal end of the vacuum and configured to slidably reciprocate and create a seal within the vacuum chamber, the plunger head comprising a polymer blend identical to the vacuum plunger.

6. The spray device according to claim 5, wherein the plunger head comprises a substantially u-shaped cross section with outwardly extending ramped seal walls configured to sealing abut interior walls of the second chamber.

7. The spray device according to claim 1, further comprising a first valve configured to control a first flow of the fluid between the reservoir and the first chamber, the first valve comprising a valve body having and a valve member configured for moment into and out of engagement with a complementary shaped valve seat of the valve body, wherein the valve member and valve body are each composed of the polymer blend having the same resin identification number.

8. The spray device according to claim 7, wherein the valve member is made of a valve member polymer blend and the valve body is made of a valve body polymer blend, wherein the valve member polymer blend is softer than the valve body polymer blend.

9. The spray device according to claim 7 further comprising a leak channel defining a gap between the valve seat and seated valve member, the leak channel allowing pressurized fluid to flow from the first chamber back into the reservoir.

10. The spray device according to claim 1, wherein the first valve is formed at the bottom of a base of the piston and plunger assembly and is in fluid communication between the reservoir and first chamber.

11. The spray device according to claim 1, further comprising a spray assembly configured to selectively discharge pressurized fluid from the fluidly connected first chamber, the spray assembly including a lever pivotally connected to the interior of a spray head and mechanically coupled a spray valve, the lever, and valve are each composed of the polymer blend having the same resin identification number.

12. The spray device according to claim 11, wherein the spray valve comprises a spray valve seat and spray valve member, the spray valve member configured to engage a complementary recess in the spray valve seat.

13. The spray device according to claim 12, wherein the spray valve member includes a valve stem configured for axial movement within a bore of the valve seat along a valve stem axis, the valve stem including a sealing portion of increased diameter configured to provide a fluid tight seal between the sealing portion and bore of the valve seat when the sealing portion is urged into contact with the valve seat.

14. The spray device according to claim 11, wherein the lever includes a pair of biasing wings positioned on and extending generally perpendicular to a valve stem axis, each basing wing is configured to couple to a biasing wall of the spray assembly and urge the lever and mechanically coupled spray valve to a sealed position, wherein upon application of a force to the lever, the valve seat is pushed along the valve seat axis and the biasing wings deform such that when the force to the lever is removed, the deformation of the biasing wings restore the lever and valve seat to the sealed position.

15. The spray device according to claim 11, wherein the spray valve is composed of a spray valve polymer blend and the spray valve member is composed of a spray valve member polymer blend, wherein the spray valve member polymer blend is softer than the spray valve polymer blend.

16. A fluid delivery device, comprising:
a reservoir configured to contain a fluid;
a chamber in fluid communication with the reservoir and configured hold an amount of pressurized fluid therein,
a first valve configured to control a first flow of the fluid between the reservoir and the first chamber, the first valve comprising a valve body having and a valve member configured for moment into and out of engagement with a complementary shaped valve seat of the valve body, and
a leak channel defining a gap between the valve seat and seated valve member, the leak channel allowing pressurized fluid to flow from the first chamber back into the reservoir,
wherein the valve member and valve body are each composed of a recyclable polymer blend.

17. The fluid delivery device according to claim 16, further comprising a first plunger configured to generate a vacuum in a second chamber responsive to movement of the first plunger in a first direction and a pistion configured to move in the first direction in response to movement of the first plunger in the first direction to cause a portion of the fluid to flow from the fluid reservoir through a flow valve and into the chamber, and configured to apply a force generated by the vacuum to the portion of the fluid in the chamber, wherein the first and second plunger are each composed of the reycyleable polymer blend.

18. The fluid delivery device according to claim 16, further comprising:
a spray assembly configured to selectively output a portion of the pressurized fluid from the chamber, the spray assembly comprising:
a spray valve seat and spray valve member, the spray valve member configured to engage a complementary recess in the spray valve seat and selectively seal the flow of pressurized fluid from the chamber; and
a lever pivotally connected to the interior of a spray head and mechanically coupled to the spray valve seat to affect disengagement of the spray valve member from the spray valve sear,
wherein all components are composed of reycyleable polymers.

19. The fluid delivery device according to claim 16, wherein the recyclable polymer blend is one of a first polymer blend having a first hardness and a second polymer blend having a second hardness, wherein the first hardness is greater than the second hardness.

20. A fluid delivery device, comprising:
a reservoir configured to contain a fluid;
a chamber in fluid communication with the reservoir and configured hold an amount of pressurized fluid therein,
a spray assembly configured to selectively output a portion of the pressurized fluid from the chamber, the spray assembly comprising:
a spray valve seat and spray valve member, the spray valve member configured to engage a complementary recess in the spray valve seat and selectively seal the flow of pressurized fluid from the chamber and
a lever pivotally connected to the interior of a spray head and mechanically coupled to the spray valve seat to affect disengagement of the spray valve member from the spray valve seat,
wherein all components are composed of recyclable polymers having the same resin identification number.
